(19) United States
(12) Patent Application Publication
(10) Pub. No.: US 2018/0053189 A1
(43) Pub. Date: Feb. 22, 2018

(54) SYSTEMS AND METHODS FOR ENHANCED AUTHORIZATION RESPONSE

(71) Applicants: Justin T. Monk, Parker, CO (US); Howard Fish, Foster City, CA (US); Shoon Ping Wong, Foster City, CA (US)

(72) Inventors: Justin T. Monk, Parker, CO (US); Howard Fish, Foster City, CA (US); Shoon Ping Wong, Foster City, CA (US)

(21) Appl. No.: 15/240,619

(22) Filed: Aug. 18, 2016

(51) Int. Cl. G06Q 20/40; H04L 29/06; H04W 12/06; H04W 4/02; G06Q 30/00

(52) U.S. Cl. CPC G06Q 20/4016; H04L 63/107; G06Q 30/0185; H04W 4/02; H04W 12/06

(57) ABSTRACT

According to embodiments of the invention, data not ordinarily sent through a transaction network can be transmitted to a resource provider (e.g., a merchant) in an authorization response message. For example, a location of an authorized user of a credential can be transmitted to a merchant to be compared to the merchant's location. This allows the merchant to determine whether to deliver goods or services to a consumer presenting the credential. In an additional or alternative example, transaction statistics can be transmitted to a merchant to allow the merchant to perform analytics. In both cases, the authorization response message serves the function of not only providing authorization services, but also authentication services (via user location) and/or data services (via statistics).

### CROSS-REFERENCES TO RELATED APPLICATIONS

None.

### BACKGROUND

Transaction security is a problem in transaction processing. Unauthorized parties may fraudulently obtain primary account numbers (PANs) and other sensitive account information through any of a number of transaction processing channels or entities. For example, unauthorized parties may obtain account information from a “skimmer” installed on a card reader that reads the magnetic stripe of a portable consumer device. In another example, unauthorized parties may hack into a merchant database and steal stored consumer payment details. In still another example, unauthorized parties may intercept payment communications between entities during transaction processing, such as between a merchant and an acquirer.

Once this account information is obtained, unauthorized parties may create fraudulent portable consumer devices that are programmed with the account information. The fraudulent portable consumer devices may appear to be authentic portable consumer devices, and may even be imprinted with the stolen account information (e.g., authorized consumer name, correct PAN, and correct card verification value). Unauthorized parties may then use the fraudulent portable consumer devices to conduct transactions, as some merchants may not verify that the identity of the party using the portable consumer device matches the name on the portable consumer device.

In addition, for fraud analyses and for other purposes, merchants may want to obtain information that may help their businesses. For example, merchants may keep their own records of their transactions and manually aggregate the data in the records to generate statistics and trends for future sales predictions. However, manually aggregating and analyzing data is inefficient and time consuming. Thus, some merchants may provide their transaction records to analytics companies that manually aggregate and analyze transactions on behalf of the merchants. This is also time consuming as it requires a significant amount of coordination on the part of the merchant.

Embodiments of the invention address these and other problems, individually and collectively.

### SUMMARY

Enhanced methods of providing useful information to merchants are desirable.

According to some embodiments of the invention, an authorization request message with a credential for a transaction between a user of a mobile device and a resource provider is received. The resource provider is associated with a resource provider computer. A user location associated with the mobile device is received from the mobile device. The authorization request message is transmitted to an authorizing entity computer. An authorization response message is received from the authorizing entity computer. The authorization response message authorizes the transaction. The user location is incorporated into the authorization response message. The authorization response message including the user location is transmitted to the resource provider computer. The resource provider computer thereafter compares the user location to a resource provider location associated with the resource provider and determines whether to complete the transaction using the credential based on the comparison.

According to some embodiments of the invention, an authorization request message is received for a transaction between a consumer and a resource provider. The resource provider is associated with a resource provider computer. The authorization request message is forwarded to an authorizing entity computer. An authorization response message is received from the authorizing entity computer that authorizes or declines the transaction. Auxiliary data, such as statistics, specific to the resource provider that is not specific to the transaction are generated. The auxiliary data is incorporated into the authorization response message. The authorization response message including the auxiliary data is transmitted to the resource provider computer. The resource provider computer thereafter performs analytics using the auxiliary data.

Embodiments of the invention are further directed to a server computer comprising a processor and a memory element. The memory element can comprise code, executable by the processor, for implementing the above described methods. Other embodiments of the invention may be directed to access devices and methods for performing transactions using such access devices.

These and other embodiments of the invention are described in further detail below.

### BRIEF DESCRIPTION OF THE DRAWINGS

FIG. 1 shows a block diagram of a system according to embodiments of the present invention.

FIG. 2 shows a block diagram of a communication device according to embodiments of the present invention.

FIG. 3 shows a block diagram of an application provider computer according to embodiments of the present invention.

FIG. 4 shows a block diagram of a transaction processing computer according to embodiments of the present invention.

FIG. 5 shows a flowchart of a method for incorporating a user location into an authorization response message according to embodiments of the present invention.

FIG. 6 shows a flowchart of a method for providing a user location to a resource provider according to embodiments of the present invention.

FIG. 7 shows a flowchart of a method for incorporating auxiliary data into an authorization response message according to embodiments of the present invention.

### DETAILED DESCRIPTION

According to some embodiments of the invention, data not ordinarily sent through a transaction network can be transmitted through the transaction network in an authorization response message to a resource provider (e.g., a merchant). For example, a location of an authorized user of a credential can be transmitted to a merchant while a transaction is occurring. The received location can be compared to the merchant's location. This allows the merchant to determine whether to deliver goods or services to a consumer presenting the credential, based upon whether or not the received location matches or is within a predetermined distance to the merchant location. In an additional or alternative example, transaction statistics can be transmitted to a merchant to allow the merchant to perform analytics. In both cases, the authorization response message serves the function of not only providing authorization services, but also authentication services (via user location) and/or data services (via statistics). Thus, embodiments of the invention are more efficient and consume fewer computing resources as compared to conventional systems that would require separate communications for authorization and authentication services.

Before discussing specific embodiments and examples, some descriptions of terms used herein are provided below.

An “access device” may be any suitable device for communicating with a resource provider computer or transaction processing computer, and for interacting with a payment device, a user computer apparatus, and/or a user mobile device. An access device may generally be located in any suitable location, such as at the location of a merchant. An access device may be in any suitable form. Some examples of access devices include POS devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a payment device and/or a user mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device.

An “application provider” may be an entity that can provide a service or application.

An “authorization request message” may be a message to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCW (dynamic card verification value), an expiration date, a PIN number, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be a message reply to an authorization request message. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

An “authorizing entity” may be an entity that authorizes a request. Examples of an authorizing entity may be an issuer, a governmental agency, a document repository, an access administrator, etc.

“Auxiliary data” may include any data or information. In some embodiments, auxiliary data is data that is not ordinarily or customarily provided in a transaction processing message, such as an authorization response message. Auxiliary data may be specific to a resource provider. In some embodiments, auxiliary data may not be specific to a transaction during which the auxiliary data is received. For example, auxiliary data may include periodic or overall statistics for a resource provider, such as an hourly transaction volume. Thus, the auxiliary data may incidentally include data about the transaction during which the auxiliary data is received (e.g., an hourly transaction volume may include the current transaction), but may also include data about other transactions during that reporting period (e.g., other transactions conducted that hour). However, if the current transaction is the only transaction conducted during a certain reporting period (e.g., over the course of an hour), it is contemplated that the auxiliary data may only include data about the current transaction.

A “communication device” may comprise any suitable electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of communication devices include mobile devices (e.g., cellular phones), PDAs, tablet computers, net books, laptop computers, personal music players, handheld specialized readers, watches, fitness bands, ankle bracelets, rings, earrings, etc., as well as automobiles with remote communication capabilities. A communication device may comprise any suitable hardware and software for performing such functions, and may also include multiple devices or components (e.g., when a device has remote access to a network by tethering to another device—i.e., using the other device as a modem—both devices taken together may be considered a single communication device).

A “portable device” may include a device that is portable. In some embodiments, a portable device may in the form of a payment device such as a credit card, debit card, or prepaid card. In other embodiments, the portable device could have other forms including wearables (smart watches), vehicles (cars), and portable communication devices such as mobile phones. In some cases, the portable device may be separate from the communication device. The portable device may also include a processor and a memory and may store credentials.

A “credential” may comprise any evidence of authority, rights, or entitlement to privileges. For example, access credentials may comprise permissions to access certain tangible or intangible assets, such as a building or a file. In another example, payment credentials may include any suitable information associated with and/or identifying an account (e.g., a payment account and/or a payment device associated with the account). Such information may be directly related to the account or may be derived from information related to the account. Examples of account information may include an “account identifier” such as a PAN (primary account number or “account number”), a token, a subtoken, a gift card number or code, a prepaid card number or code, a user name, an expiration date, a CVV (card verification value), a dCW (dynamic card verification value), a CVV2 (card verification value 2), a CVC3 card verification value, etc. An example of a PAN is a 16-digit number, such as “4147 0900 0000 1234”. In some embodiments, credentials may be considered sensitive information.

An “issuer” may typically refer to a business entity (e.g., a bank) that maintains an account for a user. An issuer may also issue payment credentials stored on communications devices.

A “resource provider” may be an entity that can provide a resource such as goods, services, information, and/or access. Examples of a resource provider include merchants, access devices, secure data access points, etc. A “merchant” may typically be an entity that engages in transactions and can sell goods or services, or provide access to goods or services.

A “server computer” may include a powerful computer or cluster of computers. For example, a server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

“Statistics” may include any collected and analyzed data. Statistics may be based on data that is collected cumulatively over any period of time. In another embodiment, statistics may be based on data that is selected randomly from a group or selected using one or more characteristics of the data. In the transaction context, statistics may include any collected transaction data, such as transaction volume, transaction rate, consumer spending volume, consumer spending rate, fraud volume, fraud rate, and the like. These transaction statistics may be provided according to any criteria, such as by resource provider, by access device, by resource provider location, by geographical location, by resource provider type, by consumer, by authorizing entity, and the like.

I. Systems

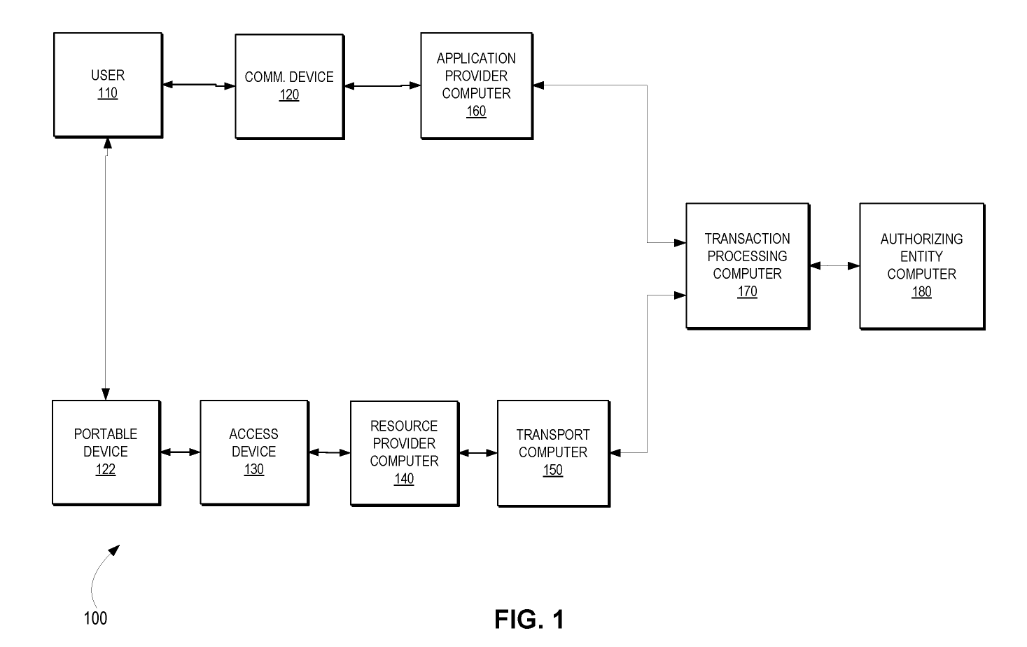

FIG. 1 shows a block diagram of system 100 according to embodiments of the present invention. The system 100 includes a communication device 120, an application provider computer 160, an access device 130, a resource provider computer 140, a transport computer 150, a transaction processing computer 170, and an authorizing entity computer 180. Each of these systems and computers may be in operative communication with each other. The communication device 120 may be operated by a user 110. The user 110 may also use a portable device 122 such as a debit or credit card when making a purchase at an access device 130.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. In addition, the components in FIG. 1 may communicate via any suitable communication medium (including the Internet), using any suitable communications protocol.

In some embodiments, communication device 120 may be suitable to carry out a financial transaction or any other additional related actions. Communication device 120 may include a memory that may store a mobile wallet application or payment application. The application may be provisioned with account information to enable each mobile device to conduct transactions. Communication device 120 may also include a secure element that can be implemented in either hardware and/or software, which may store sensitive account or personal information. In other embodiments, communication device 120 is not provisioned with account information and may not be directly used to conduct transactions. Communication device 120 may communicate over a communication network with one or more entities, including application provider computer 160 and access device 130.

The application provider computer 160 may be operated by or associated with an application provider. The application provider may be an entity that provides an application to a mobile device for use by a user. In some embodiments, the application provider can be a digital wallet provider that provides a digital wallet or payment application to a mobile device. The application provider computer 160 may maintain one or more digital wallets for each user, and each digital wallet may be associated with payment data for one or more payment accounts. Examples of digital wallets may include Visa Checkout™ or Google™ Wallet, etc. In some embodiments, the application provider computer 160 may be an entity that interfaces between communication device 120 and transaction processing computer 170 to provide a location of communication device 120 to transaction processing computer 170, as described further herein.

The application provider computer 160 may comprise a server computer to facilitate the provisioning process. The server computer may include a processor and a computer readable medium coupled to the processor, the computer readable medium comprising code, executable by the processor. The server computer may send and receive over-the-air (OTA) messages an application stored on the communication device 120.

The resource provider computer 140 may be configured to receive transaction data from an access device 130. Resource provider computer 140 may enable a resource provider such as a merchant to engage in transactions, sell goods or services, or provide access to goods or services to the consumer. The resource provider computer 140 may accept multiple forms of payment and may use multiple tools to conduct different types of transactions. In some embodiments, the resource provider computer 140 may communicate with, include, or be an access device 130 at a physical store operated by the merchant for in-person transactions. The resource provider computer 140 may also enable the merchant to sell goods and/or services via a website, and may accept payments over the Internet. In those embodiments, access device 130 may be the website.

The transport computer 150 is typically a system for an entity (e.g., a bank) that has a business relationship with a particular resource provider (e.g., merchant) or other entity. The transport computer 150 may route the authorization request for a transaction to the authorizing entity computer 180 via transaction processing computer 170. The transport computer 150 may comprise a server computer. The server computer may include a processor and a computer readable medium coupled to the processor, the computer readable medium comprising code, executable by the processor.

The transaction processing computer 170 may be associated with one or more payment service providers. The transaction processing computer 170 may include any entity that provides provisioning or personalization services. For example, the transaction processing computer 170 may maintain a personalization database with user information, and the transaction processing computer 170 may be configured to communicate with one or more authorizing entity computers 180 to determine personalized payment data for users. The transaction processing computer 170, via a provisioning service module, may provide provisioning services to the application provider computer 160, in which the application provider computer 160 may utilize an application programming interface (API) to communicate with the transaction processing computer 170. Some systems can perform both transaction processing computer 170 and application provider computer 160 functions.

The transaction processing computer 170 may comprise a server computer. The server computer may include a processor and a computer readable medium coupled to the processor, the computer readable medium comprising code, executable by the processor.

The authorizing entity computer 180 is typically run by a business entity (e.g., a bank) that may have issued a payment (credit/debit) card, account numbers or payment tokens used for the transactions. Some systems can perform both authorizing entity computer 180 and transport computer 150 functions, and/or both authorizing entity computer 180 and application provider computer 160 functions. When a transaction involves a payment account associated with the authorizing entity computer 180, the authorizing entity computer 180 may verify the account and respond with an authorization response message to the transport computer 150 that may be forwarded to the corresponding access device 130 and the consumer device 120 if applicable.

The authorizing entity computer 180 may comprise a server computer. The server computer may include a processor and a computer readable medium coupled to the processor, the computer readable medium comprising code, executable by the processor. In some embodiments, the authorizing entity computer 180 may communicate with the transaction processing computer 170 to conduct transactions.

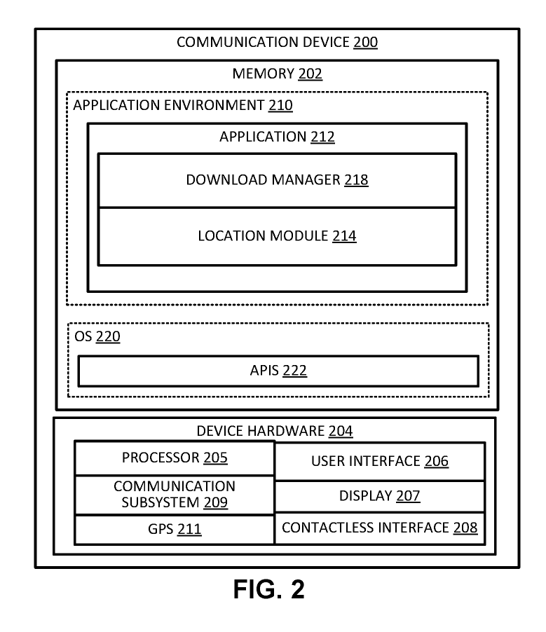

FIG. 2 shows a block diagram of a communication device 200 according to embodiments of the present invention. Communication device 200 may be used to implement communication device 120 of FIG. 1, for example. Communication device 200 may include device hardware 204 coupled to a memory 202. Device hardware 204 may include a processor 205, a communications subsystem 209, and a user interface 206. In some embodiments, device hardware 204 may include a display 207 (which can be part of user interface 206). Device hardware 204 may also include a contactless interface 208, for example, in some embodiments in which communication device 200 is a portable communication device. Device hardware 204 may further include a global positioning system (GPS) in an embodiment in which communication device 200 provides its location. However, it is contemplated that device hardware 204 may include any suitable hardware for determining the location of communication device 200. In addition, it is contemplated that other methods of determining the location of communication device 200 may be implemented without requiring any particular location determination hardware components, as described further herein.

Processor 205 can be implemented as one or more integrated circuits (e.g., one or more single core or multicore microprocessors and/or microcontrollers), and is used to control the operation of communication device 200. Processor 205 can execute a variety of programs in response to program code or computer-readable code stored in memory 202, and can maintain multiple concurrently executing programs or processes. Communications subsystem 209 may include one or more RF transceivers and/or connectors that can be used by portable communication device 200 to communicate with other devices and/or to connect with external networks. User interface 206 can include any combination of input and output elements to allow a user to interact with and invoke the functionalities of communication device 200. In some embodiments, user interface 206 may include a component such as display 207 that can be used for both input and output functions.

Contactless interface 208 may include one or more specialized RF transceivers (e.g., near field communication (NFC) transceivers) to interact with a contactless reader of an access device to conduct a transaction (e.g., payment transaction, access transaction, information exchange, etc.). In secure element based implementations, only a secure element (not shown) may have access to contactless interface 208. In some embodiments, contactless interface 208 can be accessed by the mobile OS 220 using specialized card emulation APIs 222 without requiring the use of a secure element. In some embodiments, display 207 can also be part of contactless interface 208, and is used, for example, to perform transactions using bar codes, QR codes, etc.

Memory 202 can be implemented using any combination of any number of non-volatile memories (e.g., flash memory) and volatile memories (e.g., DRAM, SRAM), or any other non-transitory storage medium, or a combination thereof media. Memory 202 may store an operating system (OS) 220 and an application environment 210 where one or more applications reside including application 212 to be executed by processor 205. In some embodiments, OS 220 may implement a set of card emulation APIs 222 that can be invoked by application 212 to access contactless interface 208 to interact with an access device.

In some embodiments, application 212 can include an application that uses, accesses, and/or stores sensitive information or tokens. For example, application 212 can include a digital wallet or payment application that uses tokens and/or payment credentials to conduct transactions via communication device 200. In some embodiments, access to application 212 by a user can be protected by user authentication data such as a password, passcode, PIN, etc. For example, when a user attempts to launch or execute application 212, the user may be requested to enter valid user authentication data before the user can access application 212.

In some embodiments, application 212 can include an application that interfaces with GPS 211 to provide a location of communication device 200 to a third party, such as an application provider computer or a transaction processing computer. Application 212 may include a download manager 218 and a location module 214. In some embodiments, one or more of these components can be provided by another application or component that is not part of application 212.

Download manager 218 can be programmed to provide functionalities to communicate with an application provider associated with application 212 to download information via the application provider. Location module 214 can be programmed to interface with GPS 211 to obtain a location of communication device 200. Location module 214, in conjunction with processor 205, may obtain the location of communication device 200 “on demand” upon receiving a request, or at any interval (e.g., every hour, every time communication device 200 is used as a payment device, etc.).

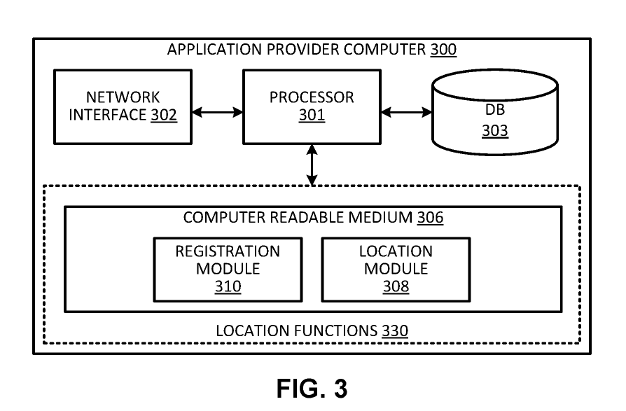

FIG. 3 shows a block diagram of an application provider computer 300 according to embodiments of the present invention. Application provider computer 300 may be implemented as application provider computer 160 of FIG. 1, for example. Application provider computer 300 may be associated with an application provider. For example, application provider computer 300 can provide a software application or services associated with the application for a communication device. Application provider computer 300 may include a processor 301 coupled to a network interface 302 and a computer readable medium 306. In some embodiments, application provider computer 300 may also include a hardware security module (HSM) 320. Application provider computer 300 may also include or otherwise have access to a database 303 that may be internal or external to application provider computer 300.

Processor 301 may include one or more microprocessors to execute program components for performing the location functions 330 of application provider computer 300. Network interface 302 can be configured to connect to one or more communication networks to allow application provider computer 300 to communicate with other entities such as a communication device operated by a user, a transaction processing computer, etc. Computer readable medium 306 may include the same or different components as memory 202 of FIG. 2. Computer readable medium 306 may store code executable by the processor 301 for implementing some or all of the location functions 330 of application provider computer 300. For example, computer readable medium 306 may include code implementing a registration module 310 and a location module 308.

Registration module 310 may work in conjunction with the processor 301 to register users with application provider computer 300, such as to associate one or more portable devices (e.g., payment devices) with a communication device for location-based authentication. For example, a user can be registered with the application provider by providing registration module 310 with user identifying information to identify the user (e.g., name, address, etc.), portable device information such as a PAN, CVV, and expiration date, and device information such as a device identifier associated with the user's communication device (e.g., a phone number) on which an application associated with the application provider is installed, etc. In some embodiments, a user may set up user authentication data (e.g., password, passcode, PIN, etc.) using the registration module 310 and the processor 301. The user authentication data can be used by application provider computer 300 to authenticate the user when the application on the user's communication device communicates with application provider computer 300. Registration module 310 may work in conjunction with the processor 301 to also allow a user to change or update the user authentication data. The registration information can be stored in a database 303. In some embodiments, the registration process can be carried out when the user first downloads the application for installation on the user's communication device, or when the user first launches and executes the application.

Location module 308 is programmed to cause the processor 301 to forward requests for a location of a communication device received from a transaction processing computer, and/or to process reported locations received from the application installed on a user's communication device. In some embodiments, upon receiving a reported location from the application on the user's communication device, location module 308 in conjunction with the processor 301 may authenticate the user and/or the communication device by verifying the user authentication data and device identifier of the communication device against the previously registered information stored in database 303. Location module 308, in conjunction with the processor 301, may then forward the reported location to a transaction processing computer. In other embodiments, the actual location of the communication device may not be received by the location module 308. Rather, data that can be used to determine the communication device's location may be received and the application provider computer 300 may determine the communication device's location from that data. For example, the application provider computer 300 may receive a signal strength (with the location of the cell tower nearest the communication device) or IP address from the communication device. From this data, the application provider computer 300 may be able to determine the approximate latitude and longitude of the communication device.

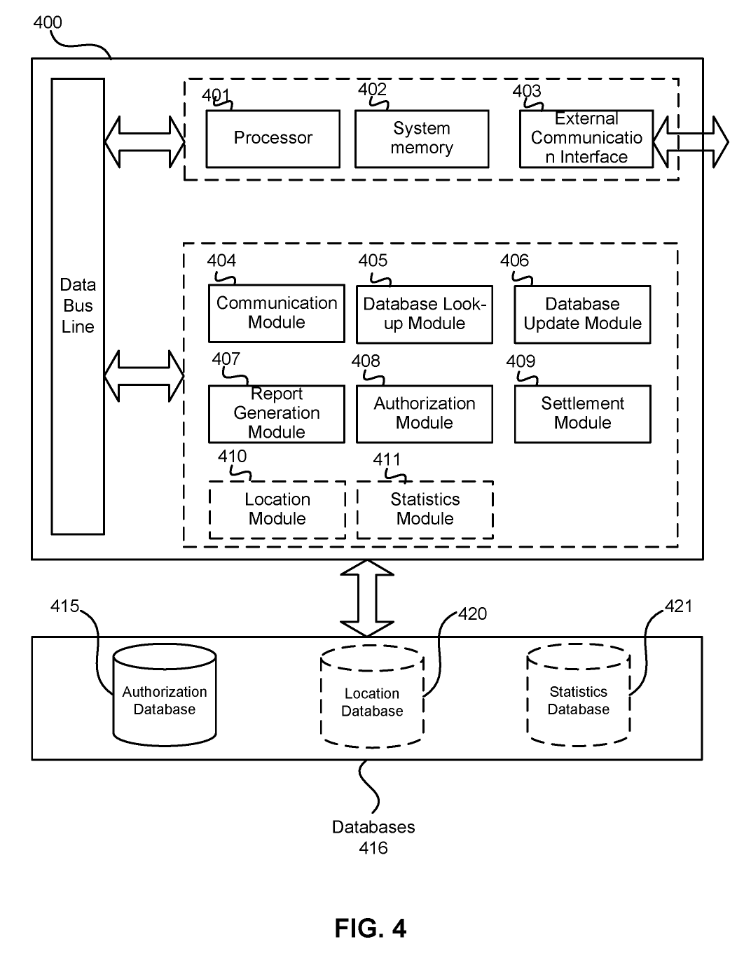

FIG. 4 shows a block diagram of a transaction processing computer 400 according to embodiments of the present invention. Transaction processing computer 400 may be used to implement transaction processing computer 170 of FIG. 1, for example. Transaction processing computer 400 is illustrated as comprising a plurality of hardware and software modules 401-411. However, it should be appreciated that this is provided for illustration purposes only, and each of the modules and associated functionality may be provided and/or performed by the same or different components. That is, transaction processing computer 400 may, for example, perform some of the relevant functions and steps described herein through the use of any suitable combination of software instructions and/or hardware configurations. It should be noted that although FIG. 4 illustrates all of the modules located on a single device, the disclosure is not meant to be so limited. Moreover, a system for implementing the functionality described herein may have additional components or less then all of these components. Additionally, some modules may be located on other devices such as a remote server or other local devices that are functionally connected to the component(s) of the transaction processing computer 400.

The transaction processing computer 400 is shown as comprising a processor 401, system memory 402 (which may comprise any combination of volatile and/or non-volatile memory such as, for example, buffer memory, RAM, DRAM, ROM, flash, or any other suitable memory device), and an external communication interface 403. Moreover, one or more of the modules 404-411 may be disposed within one or more of the components of the system memory 402, or may be disposed externally. As was noted above, the software and hardware modules shown in FIG. 4 are provided for illustration purposes only, and the configurations are not intended to be limiting. The processor 401, system memory 402 and/or external communication interface 403 may be used in conjunction with any of the modules described below to provide a desired functionality. Some exemplary modules and related functionality may be as follows.

The communication module 404 may, in conjunction with the processor 401, be configured or programmed to receive and generate electronic messages comprising information transmitted to or from any of the entities shown in FIG. 1. When an electronic message is received by the transaction processing computer 400 via external communication interface 403, it may be passed to the communication module 404. The communication module 404 may, in conjunction with the processor 401, identify and parse the relevant data based on a particular messaging protocol. The received information may comprise, for instance, identification information, transaction information, and/or any other information that the transaction processing computer 400 may utilize in authorizing a financial transaction or performing a settlement and clearing procedure. The communication module 404 may, in conjunction with the processor 401, then transmit any received information to an appropriate module within the transaction processing computer 400 (e.g. via a system bus line 450). The communication module 404 may, in conjunction with the processor 401, also receive information from one or more of the modules in transaction processing computer 400 and generate an electronic message in an appropriate data format in conformance with a transmission protocol used in the system 100 of FIG. 1 so that the message may be sent to one or more components within the system (e.g., to an authorizing entity computer or resource provider computer). The electronic message may then be passed to the external communication interface 403 for transmission. The electronic message may, for example, comprise an authorization response message (e.g., to be transmitted to a merchant conducting a transaction) or may be an authorization request message to be transmitted or forwarded to an issuer.

The database look-up module 405 may, in conjunction with the processor 401, be configured to perform some or all of the functionality associated with retrieving information from one or more databases 416. In this regard, the database look-up module 405 may, in conjunction with the processor 401, receive requests from one or more of the modules of transaction processing computer 400 (such as communication module 404, authorization module 408, or settlement module 409) for information that may be stored in one or more of the databases 416. The database look-up module 405 may, in conjunction with the processor 401, then determine and query an appropriate database. The database update module 406 may, in conjunction with the processor, maintain and update the databases 416, such as authorization database 415, location database 420, and statistics database 421. In this regard, the database update module 406 may, in conjunction with the processor 401, receive information about a user (e.g., location information), financial institution, a payment device, and/or current or past transaction information from one of the modules discussed herein. This information may then be stored in the appropriate location in the databases 416 using any suitable storage process.

The report generation module 407 may, in conjunction with the processor, be programmed or configured to perform some or all of the functionality associated with generating a report regarding a user, an account, a transaction or transactions, or any other entity or category of information with regard to system 100 of FIG. 1. This may include, for instance, identifying patterns (such as patterns that indicate a fraudulent transaction or transactions) and generating one or more alerts that may be sent (e.g., via communication module 404 and external communication interface 403) to one or more entities in the system 100 of FIG. 1, including the user, resource provider, or authorizing entity. The report generation module may also, in conjunction with the processor 401, for example, request information from one or more of the databases 416 via database look-up module 405.

The authorization module 408 may, in conjunction with the processor 401, perform some or all the functionality associated with authorizing a financial transaction associated with an authorization request message. The authorization request message may be generated by a resource provider computer and may be associated with a transaction involving a payment device. The authorization request message may include any suitable information that may be used to authorize or identify the transaction, and may be generated by the resource provider computer in response to an interaction between a payment device or a mobile device and an access device. The authorization module 408 may, for instance, in conjunction with the processor 401, compare the information received by via the authorization request message with stored information at the transaction processing computer 400 or a database 416 (such as comprising verification values). In some embodiments, if the received and stored values match, the authorization module 408 may, in conjunction with the processor 401, authorize the transaction (or may be more likely to authorize the transaction) and may instruct the communication module 401 to generate an authorization response message. The authorization module 407 may, in conjunction with the processor 401, execute any further operations associated with a typical authorization.

The location module 410 may, in conjunction with the processor 401, perform some or all of the functionality associated with requesting and/or receiving a user location from a communication device. In some embodiments, location module 410 is optionally included in the transaction processing computer 400. Location module 410 may, in conjunction with processor 401, initially register users for location-based authentication by associating one or more credentials with a particular communication device. In some embodiments, location module 410 may, in conjunction with the processor 401, thereafter receive a location of the registered communication device at periodic intervals (e.g., every hour, every day, etc.), or upon the occurrence of an event (e.g., every time or every few times the communication device is used as a payment device, etc.). In some embodiments, location module 410 may, in conjunction with the processor 401, alternatively or additionally request a location of the registered communication device at periodic intervals, or upon the occurrence of an event. For example, location module 410 may, in conjunction with the processor 401, request the location of the communication device every time or every few times an authorization request message is received containing the associated credential (e.g., payment device number).

Location module 410 may, in conjunction with the processor 401, request the location of the communication device based on any number of conditions as well. For example, location module 410 may, in conjunction with the processor 401, request the location of the communication device every time an authorization request message is received containing the associated credential when the authorization request message is for a transaction above a threshold amount, originates from a particular resource provider or type of resource provider, originates from a particular geographic location (e.g., outside of a particular state, outside of the United States, outside a threshold distance of a user's home or work, etc.), and the like. The methods of obtaining the location (i.e., by request or by pushing the location), the intervals at which to obtain the location, and/or the conditions under which to obtain the location may be specified by the user during registration with location module 410 in one embodiment. The location of the communication device can be provided to a resource provider by transaction processing computer 400 in an authorization response message for a transaction using the registered credential.

As described further herein, location module 410 may also, in conjunction with the processor 401, receive access device IDs and retrieve the corresponding access device locations from location database 420.

The statistics module 411 may, in conjunction with the processor 401, perform some or all of the functionality associated with computing and providing statistics for one or more transactions. In some embodiments, statistics module 411 is optionally included in the transaction processing computer 400. Statistics module 411 may, in conjunction with processor 401, initially register resource providers with transaction processing computer 400 to receive statistics regarding transactions. In some embodiment, statistics module 411 may thereafter analyze transaction data to compute statistics and transmit the statistics to a resource provider in an authorization response message for a transaction. Although the statistics may include data from the transaction for which the authorization response message is sent, they are not specific to the transaction and may not have any bearing on the particular transaction.

The statistics module 411 may, in conjunction with the processor 401, calculate and provide the statistics according to any criteria. For example, the statistics module 411 may be configured to calculate statistics based on transactions performed by a particular resource provider, by a particular access device or set of access devices at a resource provider, by location (e.g., resource provider location or general geographic location), by a particular type of resource provider, combinations thereof, and the like. For example, the statistics module 411 may, in conjunction with the processor 401, calculate and provide to a coffee shop statistics regarding consumer spending at that particular coffee shop, as well as overall consumer spending at all coffee shops in that city. The statistics module 411 may, in conjunction with the processor 401, calculate the statistics over any period of time (e.g., over an hour, over a day, over a week, over a lifetime, over the past 100 transaction, etc.).

In addition, the statistics provided by statistics module 411 may accompany any authorization response message to a subscribed resource provider. For example, updated, cumulative statistics may be calculated and provided with every authorization response message, in every few authorization response messages, once per hour, once per day, once per week, etc., regardless of any particular details of the underlying transaction (e.g., regardless of whether the transaction was authorized or declined in the authorization response message). The criteria for calculating and providing the statistics, as well as the frequency and duration of the statistics, may be specified by the resource provider during registration with statistics module 411 in one embodiment.

The transaction processing computer 400 may include one or more databases 416, such as authorization database 415, location database 420, and/or statistics database 421. Each of the databases shown in this example may comprise more than one database, and may be located in the same location or at different locations. The authorization database 415 may contain information related to a payment device and/or a credential, as well as any other suitable information (such as transaction information) associated with the credential. For example, the authorization database 415 may comprise a relational database having a plurality of associated fields, including a primary account identifier (e.g., a PAN), an issuer associated with the account, expiration date of a payment device, a verification value(s), an amount authorized for a transaction, a user name, user contact information, prior transaction data, etc. In some embodiments, the authorization module 408 may utilize some or all of the information stored in the authorization database 415 when authorizing a transaction.

The location database 420 may contain information regarding registered communication devices and their associated credentials for location module 410. The location database 420 may further store some or all of the obtained locations of the communication devices. In one embodiment, the location database 420 may store only the most recent obtained location of a communication device. The statistics database 421 may contain statistical data computed by statistics module 411 from information stored in the authorization database 415 (e.g., past and current transaction data).

The location database 420 may additionally contain locations of access devices mapped to access device IDs, such that access devices may provide access device IDs to the transaction processing computer 400 in lieu of their locations. In this embodiment, location module 410 may, in conjunction with the processor 401, receive an access device ID and extract the corresponding access device location from the location database 420 in order to compare the access device location to the communication device location. The access device IDs and corresponding locations may be stored in location database 420 after a registration process by the resource providers of their access devices with the transaction processing computer 400.

II. Methods

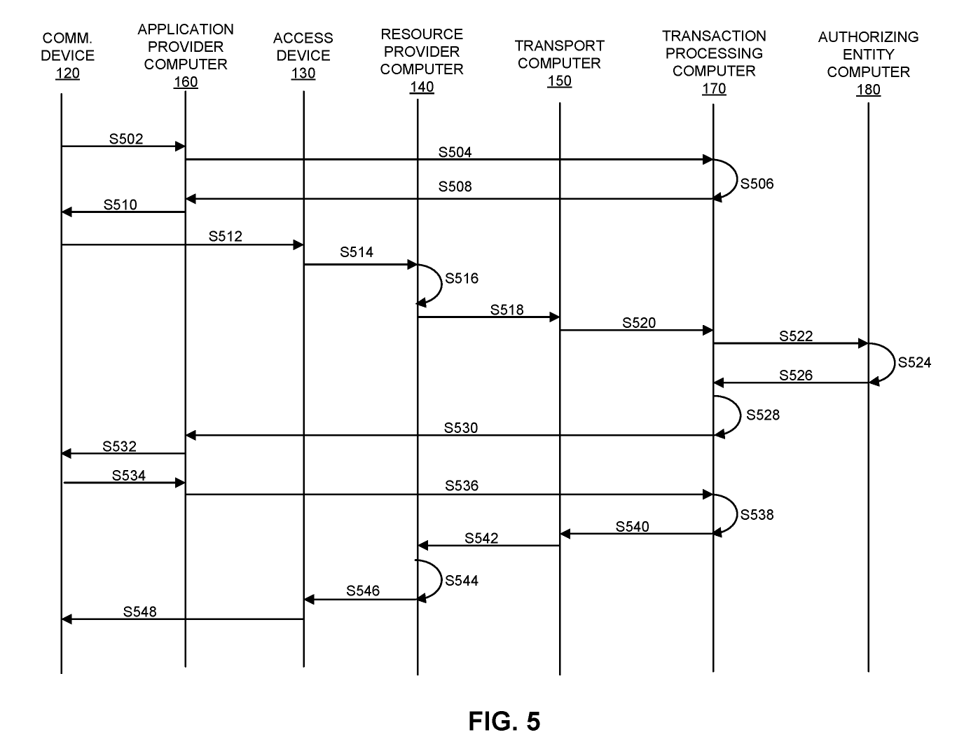

A method according to embodiments of the invention can be described with respect to FIG. 5, which shows a flow diagram illustrating a method for incorporating a user location into an authorization response message according to embodiments of the present invention. FIG. 5 includes communication device 120, application provider computer 160, access device 130, resource provider computer 140, transport computer 150, transaction processing computer 170, and authorizing entity computer 180. FIG. 5 may be described with reference to FIG. 1.

At step S502, the communication device 120 sends a request to register for location-based authentication to application provider computer 160. The request includes one or more credentials (e.g., PANs or tokens) which, when used during a transaction, will trigger the location-based authentication using the communication device 120. The request may further include an identifier associated with the communication device 120 (e.g., a mobile phone number or device ID) that may be used to request a location from communication device 120 and/or that may accompany the reported location from communication device 120 so that the reported location may be matched to the associated credential and transaction.

In one embodiment, at step S504, the application provider computer 160 may register the communication device 120 and send the registration details (i.e., communication device 120 identifier, credential(s), etc.) to the transaction processing computer 170, which records the details at step S506. In another embodiment, at step S504, the application provider computer 160 forwards the communication device 120 identifier and credential(s) to the transaction processing computer 170, which registers the communication device 120 at step S506 and records the details. In some embodiments, application provider computer 160 and transaction processing computer 170 may be combined. At step S508, the transaction processing computer 170 sends a confirmation of enrollment message to the application provider computer 160. At step S510, the application provider computer 160 sends the confirmation of enrollment message to the communication device 120.

Although shown and described as involving a separate enrollment process, it is contemplated that in some embodiments of the invention, the communication device 120 may be enrolled or registered for location-based authentication automatically or as part of a separate enrollment process. For example, the communication device 120 may be enrolled in location-based authentication when a new credential (e.g., a new payment device or token) is issued or activated, or when a new credential is provisioned onto the communication device 120.

At step S512, communication device 120 is used at an access device 130 as a payment device transferring a credential for a transaction, such as through a contactless interface. In other embodiments, communication device 120 may not be used as a payment device, and a separate payment device (e.g., a credit card, a debit card, a prepaid card, etc.), such as portable device 122 of FIG. 1, may be used to provide a credential for a transaction.

At step S514, the access device 130 provides the credential and transaction details (e.g., total amount) to the resource provider computer 140. The access device 130 may additionally include the location of access device 130 or data that can be used to determine the location of access device 130 (e.g., a physical address, coordinates, merchant identifier that can be correlated to the access device, etc.). Data that can be used to determine the location of the access device 130 may include a merchant or access device ID that may be correlated to a predetermined location such as a predetermined latitude and longitude location stored at the transaction processing computer 170 and/or the application provider computer 160.

At step S516, the resource provider computer 140 generates an authorization request message with the credential and the transaction details. At step S518, the resource provider computer 140 transmits the authorization request message to a transport computer 150. At step S520, the transport computer 150 sends the authorization request message to a transaction processing computer 170.

At step S522, the transaction processing computer 170 sends the authorization request message to an authorizing entity computer 180 that is associated with the credential. At step S524, the authorizing entity computer 180 determines whether or not to authorize the transaction (e.g., based on the amount of available funds associated with the credential) and generates an authorization response message. For purposes of this embodiment, the authorization response message approves the transaction.

At step S526, the authorizing entity computer 180 sends the authorization response message to the transaction processing computer 170. At step S528, the transaction processing computer 170 determines whether the credential contained in the authorization response message is enrolled in location-based authentication. For purposes of this embodiment, the credential contained in the authorization response message is indeed enrolled in location-based authentication, and is stored in association with communication device 120 by transaction processing computer 170.

At step S530, the transaction processing computer 170 sends a request for the location of communication device 120 or data that can be used to determine the location of the communication device 120 to the application provider computer 160. The transaction processing computer 170 may determine the proper application provider computer 160 and communication device 120 to which to route the request through information associated with the credential. At step S532, the application provider computer 160 forwards the request to the communication device 120. Although described in this embodiment as being requested by the transaction processing computer 170, it is contemplated that the communication device 120 may instead push its location to the application provider computer 160 (and/or the transaction processing computer 170) without an explicit request and at any time, as described further herein.

At step S534, in some embodiments, the communication device 120 obtains its location or data that can be used to determine its location. The communication device 120 may obtain its location or data that can be used to determine its location through any of a number of methods. For example, the communication device 120 may obtain its location or data that can be used to determine its location through a GPS device located on or with the communication device 120. In another example, the communication device 120 may obtain its location or data that can be used to determine its location by evaluating its signal strength to cell towers having known locations.

Further at step S534, the communication device 120 provides its location or data that can be used to determine its location to the application provider computer 160. The communication device 120 may provide its location in any format. For example, the communication device 120 may provide a pin to a specific location, particular GPS coordinates, a latitude and longitude, and/or a physical address. In another example, the communication device 120 may provide its signal strength to specific cell towers having locations known to application provider computer 160, which application provider computer 160 may then use to determine the position of the communication device 120. In still another example, the communication device 120 may transmit its Internet Protocol (IP) address to the application provider computer 160, which the application provider computer 160 may then analyze to determine the location of the communication device 120. Thus, it is contemplated that not all embodiments require that the communication device 120 include a location determination component (e.g., a GPS). At step S536, the application provider computer 160 forwards the location communication device 120 or data that can be used to determine its location of to the transaction processing computer 170.

At step S538, the transaction processing computer 170 determines the location of the communication device 120 and updates the authorization response message received at step S526 with the determined location of the communication device 120. At step S540, the transaction processing computer 170 sends the authorization response message with the location to the transport computer 150. At step S542, the transport computer 150 sends the authorization response message with the location to the resource provider computer 140.

At step S544, the resource provider computer 140 extracts the location of communication device 120 from the authorization response message. The resource provider computer 140 compares the location of the communication device 120 to one or more locations associated with the resource provider computer 140. For example, the resource provider computer 140 may compare the location of the communication device 120 to the location of the resource provider computer 140. The resource provider computer 140 may alternatively or additionally compare the location of the communication device 120 to the location of the access device 130. Based on this comparison (e.g., based on whether the locations are within a threshold distance of each other), the resource provider computer 140 may make its own determination of whether or not to complete the transaction. For example, if the locations are within a threshold distance of each other, the resource provider computer 140 may decide that the goods or services should be delivered to the user initiating the transaction, and may indicate this to access device 130 at step S546. In another example, if the locations are not within a threshold distance of each other, the resource provider computer 140 may decide that the goods or services should not be delivered to the user initiating the transaction, and may indicate this to access device 130 at step S546. These results may further be provided by access device 130 to communication device 120 at step S548.

At a later time after the transaction (e.g., at the end of the day), a clearing and settlement process can occur between the transport computer 150, the transaction processing computer 170, and the authorizing entity computer 180.

Thus, by determining whether the user of communication device 120 is in the vicinity of a resource provider when a transaction is initiated there using a credential associated with communication device 120, fraud by unauthorized parties attempting to use the credential may be prevented. Advantageously, these embodiments provide a secure and efficient method of location-based authentication that do not require separate systems or additional software, because the data is transmitted in an existing payment processing message (i.e., an authorization response message). The authorization response message thus provides two services in a single message: transaction authorization services and location-based authentication services. Furthermore, some embodiments of the invention are implemented at a central transaction processing computer 170 that may service multiple resource provider computers 140. Thus, each resource provider does not need to provide its own location-based authentication services, which would require consumers to register with and maintain multiple different authentication applications with multiple different resource providers.

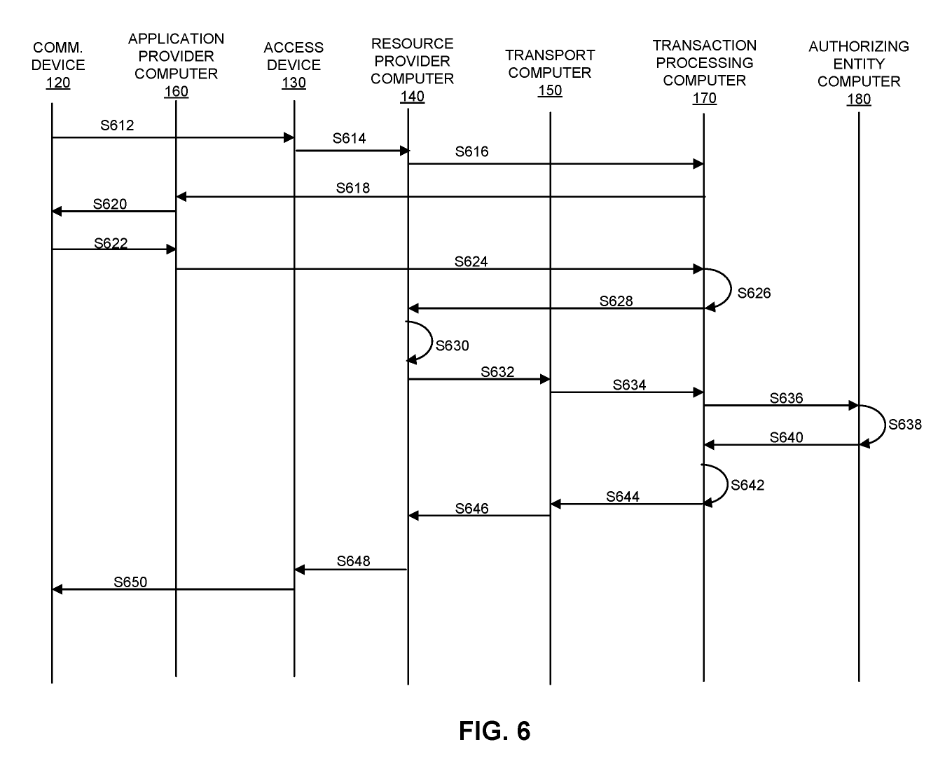

FIG. 6 shows a flowchart of a method for providing a user location to a resource provider according to embodiments of the present invention. FIG. 6 includes communication device 120, application provider computer 160, access device 130, resource provider computer 140, transport computer 150, transaction processing computer 170, and authorizing entity computer 180. FIG. 6 may be described with reference to FIG. 1.

Although not shown, the method illustrated in FIG. 6 may begin with steps S502-S510 of FIG. 5 as either a separate enrollment process or as an automatic enrollment process upon issuance, activation and/or provisioning of a new credential.

At step S612, communication device 120 is used at an access device 130 as a payment device transferring a credential for a transaction, such as through a contactless interface. In other embodiments, communication device 120 may not be used as a payment device, and a separate payment device (e.g., a credit card, a debit card, a prepaid card, etc.), such as payment device 122 of FIG. 1, may be used to provide a credential for a transaction.

At step S614, the access device 130 provides the credential and transaction details (e.g., total amount) to the resource provider computer 140. The access device 130 may additionally include an indication of the location of access device 130 (e.g., a physical address, coordinates, merchant identifier that can be correlated to the access device, etc.).

At step S616, the resource provider computer 140 sends a request for the location of communication device 120 to transaction processing computer 170. The request may in the form of a first authorization request message (e.g., an ISO 8583 message) and may contain a credential associated with a payment device. The request may further include the location of access device 130 or data that can be used to determine the location of the access device 130, and/or the credential from a portable device. Data that can be used to determine the location of the access device 130 may include a merchant or access device ID that may be correlated to a predetermined location such as a predetermined latitude and longitude location stored at the transaction processing computer 170 and/or the application provider computer 160. In addition, because the transmission in step S616 is not requesting authorization for the transaction, but is requesting a location of the mobile communication device, it may include zero dollars, no dollars, or a nominal amount (e.g., $0.02) in the amount field so that the transaction processing computer 170 knows that the first authorization request message is not requesting authorization for the transaction.

At step S618, the transaction processing computer 170 sends the request for the location of communication device 120 or data that can be used to determine the location of the communication device 120 to the application provider computer 160 to send to the communication device 120 at step S620. The transaction processing computer 170 may determine the proper application provider computer 160 and communication device 120 to which to route the request through information associated with the registered credential.

At step S622, in some embodiments, the communication device 120 obtains its location or data that can be used to determine its location. The communication device 120 may obtain its location or data that can be used to determine its location through any of a number of methods, as described above with respect to FIG. 5. Further at step S622, the communication device 120 provides its location or data that can be used to determine its location to the application provider computer 160. The communication device 120 may provide its location or data that can be used to determine its location in any format, as described above with respect to FIG. 5. At step S624, the application provider computer 160 forwards the location of communication device 120 or data that can be used to determine its location to the transaction processing computer 170.

At step S626, the transaction processing computer 170 determines the location of the communication device 120 and the access device. In some cases, the transaction processing computer 170 may convert data received from communication device 120 into a common format to the location of the access device 130. It then compares the location of communication device 120 to the location of access device 130, and determines a match result. For example, if the communication device 120 is within a threshold distance (e.g., 500 feet) of access device 130, the transaction processing computer 170 may determine that the locations match. If the communication device 120 is not within a threshold distance of access device 130, the transaction processing computer 170 may determine that the locations do not match.

At step S628, the transaction processing computer 170 provides the match result to the resource provider computer 140. At step S630, the resource provider computer 140 determines whether to generate and send an authorization request message for the transaction. In some embodiments, resource provider computer 140 makes this determination automatically and, in some embodiments, causes an authorization response message to be generated and sent automatically. For example, if the match result indicates that the locations of communication device 120 and access device 130 match, the resource provider computer 140 may automatically generate and send an authorization request message for the transaction. The authorization response message may be generated using the credential and the information previously provided to the resource provider computer 140 by the access device 130. If the match result indicates that the locations of communication device 120 and access device 130 do not match, the resource provider computer 140 may automatically terminate the transaction without proceeding further.

Assuming that the match result indicates that the location of communication device 120 and access device 130 match, the resource provider computer 140 sends a second authorization request message for the transaction to transport computer 150 at step S632. At step S634, the transport computer 150 sends the second authorization request message to the transaction processing computer 170. At step S636, the transaction processing computer sends the authorization request message to the authorizing entity computer 180. The authorizing entity computer 180 may be associated with the authorizing entity that issued the credential used for the transaction. At step S638, the authorizing entity computer 180 determines whether or not to authorize the transaction (e.g., based on the amount of available funds associated with the credential) and generates an authorization response message. For purposes of this embodiment, the authorization response message approves the transaction.

At step S640, the authorizing entity computer 180 sends the authorization response message to the transaction processing computer 170. At step S642, the transaction processing computer 170 modifies the authorization response message according to some embodiments. The modification may include the location of the communication device 120, the location of the access device 130, and/or the match result. In some embodiments, the authorization response message is not modified to include this information.

At step S644, the transaction processing computer 170 sends the authorization response message to the transport computer 150. At step S646, the transport computer 150 sends the authorization response message to the resource provider computer 140. At step S648, the resource provider computer 140 sends the authorization response message to the access device 130.

In embodiments in which the location of the communication device 120 is included in the authorization response message, the access device 130 may use the location to confirm the match result provided by transaction processing computer 170. If the access device 130 determines that the match result provided by transaction processing computer 170 is incorrect (e.g., the locations are not within a threshold distance, or a different threshold distance should be applied), the access device 130 may decide not to deliver the goods or services to the requesting user, and may reverse the transaction, for example. Otherwise, the access device 130 may proceed with completing the transaction and delivering the goods or services. The result of the transaction may further be provided by access device 130 to communication device 120 (or a user of communication device 120) at step S650.

At a later time after the transaction (e.g., at the end of the day), a clearing and settlement process can occur between the transport computer 150, the transaction processing computer 170, and the authorizing entity computer 180.

The embodiment in FIG. 6 differs from FIG. 5 in that a first authorization request and a second authorization request are used in FIG. 6, whereas one authorization request is used in FIG. 5. The embodiment in FIG. 6 can advantageously allow the merchant to determine if it should or should not submit a real transaction authorization at all. This prevents unnecessary chargeback transactions that might have otherwise resulted because the issuer approved a transaction, whereas a merchant might not want to approve of the transaction.

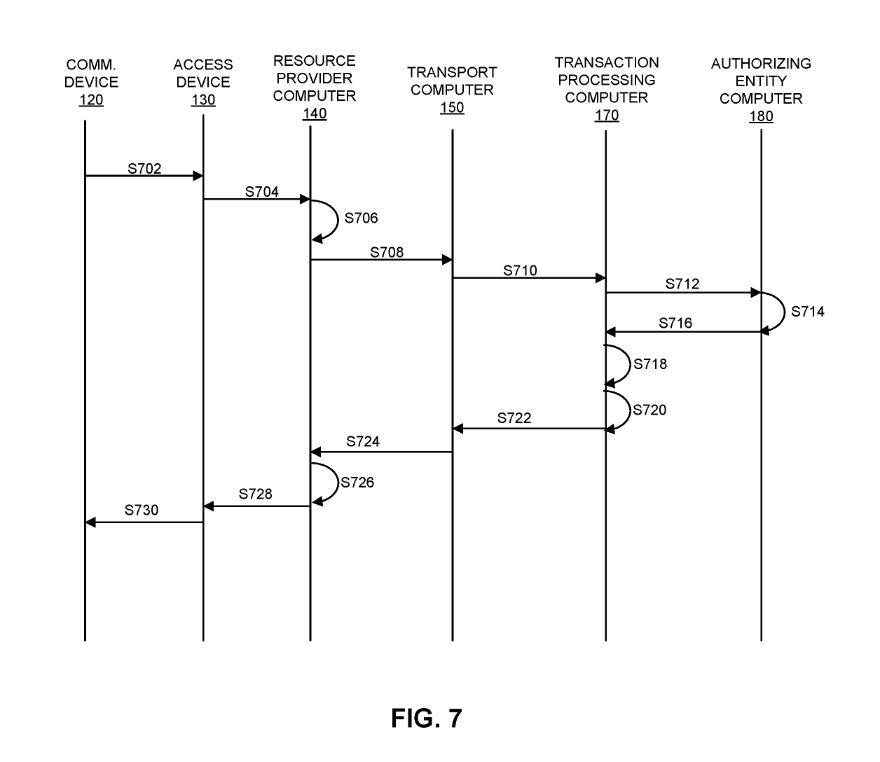

FIG. 7 shows a flowchart of a method for incorporating auxiliary data into an authorization response message according to embodiments of the present invention. FIG. 7 includes a communication device 120, an access device 130, a resource provider computer 140, a transport computer 150, a transaction processing computer 170, and an authorizing entity computer 180. FIG. 7 may be described with reference to FIG. 1. In addition, FIG. 7 may be performed in combination with or separate from the flowcharts depicted in FIGS. 5 and/or 6.

At step S702, in some embodiments, communication device 120 is used at an access device 130 as a payment device transferring a credential to initiate a transaction, such as through a contactless interface. In other embodiments, communication device 120 may not be used as a payment device, and a separate payment device (e.g., a credit card, a debit card, a prepaid card, etc.) may be used to provide a credential for a transaction.

At step S704, the access device 130 provides the credential and transaction details (e.g., total amount of the transaction) to the resource provider computer 140. At step S706, the resource provider computer 140 generates an authorization request message with the credential and the transaction details. At step S708, the resource provider computer 140 transmits the authorization request message to a transport computer 150. At step S710, the transport computer 150 sends the authorization request message to a transaction processing computer 170.

At step S712, the transaction processing computer 170 sends the authorization request message to an authorizing entity computer 180 that is associated with the credential. At step S714, the authorizing entity computer 180 determines whether or not to authorize the transaction (e.g., based on the amount of available funds associated with the credential) and generates an authorization response message authorizing or declining the transaction.

At step S716, the authorizing entity computer 180 sends the authorization response message to the transaction processing computer 170. At step S718, the transaction processing computer 170 generates or retrieves auxiliary data to be used by resource provider computer 140. In one embodiment, the auxiliary data may be specific to the resource provider associated with resource provider computer 140, but not specific to this particular transaction. However, the auxiliary data may include data regarding the particular transaction, sometimes in conjunction with other data regarding other transactions. The auxiliary data may include statistics, for example, that may be generated by statistics module 411 of FIG. 4, for example, as described further herein, and may include, for example, a transaction volume over a time period for the resource provider associated with resource provider computer 140, a fraud rate over a time period for the resource provider, and/or consumer spending over a time period at the resource provider.

At step S720, the transaction processing computer 170 updates the authorization response message received at step S716 with the auxiliary data. At step S722, the transaction processing computer 170 sends the authorization response message with the auxiliary data to the transport computer 150. At step S724, the transport computer 150 sends the authorization response message with the auxiliary data to the resource provider computer 140.

At step S726, the resource provider computer 140 performs analytics using the auxiliary data. For example, resource provider computer 140 may analyze statistics to determine if consumer spending at the resource provider is competitive with consumer spending at related resource providers in the area on a particular day. The resource provider associated with resource provider computer 140 may then take any appropriate actions based on those analytics, such as implementing a sale to increase consumer spending at the resource provider. In another example, resource provider computer 140 may analyze the statistics to determine if a new advertising campaign has increased consumer spending at the resource provider.

At step S728, resource provider computer 140 provides the result of the authorization response message (or the authorization response message itself) to the access device 130. At step S730, the access device 130 provides the result to the communication device 120 (or a user associated with communication device 120). When the transaction is approved, the result may come in the form of a receipt and/or delivery of the goods or services.

At a later time after the transaction (e.g., at the end of the day), a clearing and settlement process can occur between the transport computer 150, the transaction processing computer 170, and the authorizing entity computer 180.

Advantageously, these embodiments provide a method of providing statistics to a resource provider without requiring separate systems or additional software, because the data is transmitted is an existing payment processing message (i.e., an authorization response message). The authorization response message thus provides two services in a single message: transaction authorization services and statistics services. Furthermore, some embodiments of the invention are implemented at a central transaction processing computer 170 that may service multiple resource provider computers 140. Thus, each resource provider does not need to track and calculate its own statistics. Further, the resource providers may have access to statistical data that would not ordinarily be available to them, such as statistics of larger groups of resource providers (e.g., based on resource provider type or location).

A computer system may be used to implement any of the entities or components described above. The subsystems of the computer system may be interconnected via a system bus. Additional subsystems such as a printer, keyboard, fixed disk (or other memory comprising computer readable media), monitor, which is coupled to display adapter, and others may be used. Peripherals and input/output (I/O) devices, which couple to an I/O controller (which can be a processor or other suitable controller), can be connected to the computer system by any number of means known in the art, such as a serial port. For example, a serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer readable medium. In some embodiments, the monitor may be a touch sensitive display screen.

A computer system can include a plurality of the same components or subsystems, e.g., connected together by an external interface or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents. For example, although specific functions and methods have been described with respect to transaction processing computer 170 in FIGS. 5-7, such functions could be performed by other computers such as the authorizing entity computer 180.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer, an authorization request message with a credential for a transaction between a user of a mobile device and a resource provider, wherein the resource provider is associated with a resource provider computer;
receiving, by the server computer, a user location associated with the mobile device from the mobile device;
transmitting, by the server computer, the authorization request message to an authorizing entity computer;
receiving, by the server computer, an authorization response message from the authorizing entity computer, wherein the authorization response message authorizes the transaction;
incorporating, by the server computer, the user location into the authorization response message; and
transmitting, by the server computer, the authorization response message including the user location to the resource provider computer, wherein the resource provider computer thereafter compares the user location to a resource provider location associated with the resource provider and determines whether to complete the transaction using the credential based on the comparison.

2. The method of claim 1, wherein the authorization response message is transmitted to the resource provider computer via a transport computer.

3. The method of claim 1, wherein the resource provider location is a location of an access device associated with the resource provider, and wherein the access device was used to initiate the transaction between the user of the mobile device and the resource provider.

4. The method of claim 1, further comprising:
computing, by the server computer, a risk score using the user location; and
incorporating, by the server computer, the risk score into the authorization response message.

5. The method of claim 1, wherein the user location is received from a global positioning system (GPS) associated with the mobile device.

6. The method of claim 1, wherein the resource provider computer comparing the user location to the resource provider location comprises determining whether the user location is within a threshold of the resource provider location.

7. The method of claim 6, further comprising:
receiving, by the server computer from the resource provider computer, an indication that the user location is not within the threshold of the resource provider location;
generating, by the server computer, a notification of unauthorized usage of the credential; and
transmitting, by the server computer, the notification to the mobile device.

8. The method of claim 1, further comprising:
transmitting, by the server computer, a request for the user location associated with the mobile device to the mobile device.

9. The method of claim 1, wherein the user location associated with the mobile device is received by the server computer from the mobile device at intervals.

10. A server computer comprising:
a processor; and
a memory element comprising code, executable by the processor, for implementing a method comprising:
receiving an authorization request message with a credential for a transaction between a user of a mobile device and a resource provider, wherein the resource provider is associated with a resource provider computer;
receiving a user location associated with the mobile device from the mobile device;
transmitting the authorization request message to an authorizing entity computer;
receiving an authorization response message from the authorizing entity computer, wherein the authorization response message authorizes the transaction;
incorporating the user location into the authorization response message;
transmitting the authorization response message including the user location to the resource provider computer, wherein the resource provider computer thereafter compares the user location to a resource provider location associated with the resource provider and determines whether to complete the transaction using the credential based on the comparison.

11. The server computer of claim 10, wherein the authorization response message is transmitted to the resource provider computer via a transport computer.

12. The server computer of claim 10, wherein the resource provider location is a location of an access device associated with the resource provider, and wherein the access device was used to initiate the transaction between the user of the mobile device and the resource provider.

13. The server computer of claim 10, the method further comprising:
computing a risk score using the user location; and
Incorporating the risk score into the authorization response message.

14. The server computer of claim 10, wherein the user location is received from a global positioning system (GPS) associated with the mobile device.

15. The server computer of claim 10, wherein the resource provider computer comparing the user location to the resource provider location comprises determining whether the user location is within a threshold of the resource provider location.

16. The server computer of claim 15, the method further comprising:
receiving, from the resource provider computer, an indication that the user location is not within the threshold of the resource provider location;
generating a notification of unauthorized usage of the credential; and
transmitting the notification to the mobile device.

17. The server computer of claim 10, the method further comprising:
Transmitting a request for the user location associated with the mobile device to the mobile device.

18. The server computer of claim 10, wherein the user location associated with the mobile device is received by the server computer from the mobile device at intervals.

19. A method comprising:
receiving, by a server computer, an authorization request message for a transaction between a consumer and a resource provider, wherein the resource provider is associated with a resource provider computer;
forwarding, by the server computer, the authorization request message to an authorizing entity computer;
receiving, by the server computer, an authorization response message from the authorizing entity computer authorizing or declining the transaction;
generating, by the server computer, auxiliary data specific to the resource provider that is not specific to the transaction;
incorporating, by the server computer, the auxiliary data into the authorization response message;
transmitting, by the server computer, the authorization response message including the auxiliary data to the resource provider computer, wherein the resource provider thereafter performs analytics using the auxiliary data.

20. The method of claim 19, wherein the auxiliary data includes statistics.

21. The method of claim 20, wherein the statistics include a transaction volume over a time period for the resource provider.

22. The method of claim 20, wherein the statistics include a fraud rate over a time period for the resource provider.

23. The method of claim 20, wherein the statistics include consumer spending over a time period at the resource provider.

24. A server computer comprising:
a processor; and
a memory element comprising code, executable by the processor, for implementing a method comprising:
receiving an authorization request message for a transaction between a consumer and a resource provider, wherein the resource provider is associated with a resource provider computer;
forwarding the authorization request message to an authorizing entity computer;
receiving an authorization response message from the authorizing entity computer authorizing or declining the transaction;
generating auxiliary data specific to the resource provider that is not specific to the transaction;
incorporating the auxiliary data into the authorization response message;
transmitting the authorization response message including the auxiliary data to the resource provider computer, wherein the resource provider thereafter performs analytics using the auxiliary data.

25. The server computer of claim 24, wherein the auxiliary data includes statistics.

26. The server computer of claim 25, wherein the statistics include a transaction volume over a time period for the resource provider.

27. The server computer of claim 25, wherein the statistics include a fraud rate over a time period for the resource provider.

28. The server computer of claim 25, wherein the statistics include consumer spending over a time period at the resource provider.

29. A method comprising:
receiving, by a server computer from a resource provider computer, a credential associated with a user, a request for a location of a mobile device of the user, and a location of an access device associated with the resource provider computer, wherein the credential, the request and the location of the access device are received from the resource provider computer during a transaction by the user at the access device;
determining, by the server computer, an identifier of the mobile device using the credential;
transmitting, by the server computer, the request to the mobile device using the identifier;
receiving, by the server computer, the location of the mobile device;
determining, by the server computer, a positive match result when the location of the access device and the location of the mobile device are within a threshold distance; and
transmitting, by the server computer, the positive match result to the resource provider computer, wherein the resource provider computer thereafter generates an authorization request message for the transaction.
